(19) United States
(12) Patent Application Publication
(10) Pub. No.: US 2014/0000988 A1
(43) Pub. Date: Jan. 2, 2014

(54) LONGITUDINAL RESTRAINT

(71) Applicant: BARDEX CORPORATION, Goleta, CA (US)

(72) Inventor: Nick Atallah, Goleta, CA (US)

(21) Appl. No.: 13/929,398

(22) Filed: Jun. 27, 2013

Related U.S. Application Data
(60) Provisional application No. 61/665,210, filed on Jun. 27, 2012.

(51) Int. Cl. F16C 29/10

(52) U.S. Cl. CPC F16C 29/10
USPC 188/63

(57) ABSTRACT

Systems and methods for longitudinally restraining a movable structure disclosed herein include, but are not limited to, providing a rack attached to a first structure and a chock attached to a second structure, wherein the rack and chock are configured to engage one another. Upon engagement, the chock may be locked into place with extendable jack screws, thereby restraining the movable structure in the longitudinal direction.

### CROSS-REFERENCE TO RELATED APPLICATIONS

This Application claims the benefit of U.S. Provisional Application 61/665,210 filed on Jun. 27, 2012.

### TECHNICAL FIELD

### Background of the Invention

The present invention relates to a locking system for movable structures. Large structures such as drilling facilities on offshore platforms are periodically repositioned as necessary for drilling operations. A typical repositioning method is to skid the facilities on skid beams or capping rails. Once positioned, these facilities must be stabilized and secured against external loads caused by such things as seismic events or high wind loadings. A need exists to quickly and securely lock the structure in position.

### BRIEF SUMMARY OF THE INVENTION

An object of the present disclosure is directed to a system and method for locking movable structures. According to one aspect of the present disclosure, there is provided a longitudinal restraint system comprising a rack attached to a first structure, a chock coupled to a second structure, an actuating device configured to move the chock in relation to the rack, and a jack screw coupled to the second structure, wherein a portion of the jack screw is configured to engage a portion of the chock. In the exemplary embodiment, the rack comprises a plurality of teeth and the chock comprises a plurality of matching teeth, such that the rack and the chock may engage, thereby resulting in high friction along the longitudinal direction of the rack.

In the exemplary embodiment, the rack is affixed to the deck of a vessel through welding, bolting, or other means known to those skilled in the art. The rack may have a longitudinal direction according the longitudinal direction of the skid beams. For example, it would be known to one skilled in the art of platform drilling, that a movable structure such as an offshore rig may be moved in the stern to bow direction but also in the port to starboard direction. Racks may be placed accordingly. In the exemplary embodiment, the racks follow the direction and location according to the placement of skidding beams along the surface of a vessel. The racks may also be placed on the side or undercarriage of the skidding beam itself, according to one embodiment of the disclosure.

In one embodiment, the longitudinal restraint system is employed in regions, both land and sea, of high seismic activity. In still another embodiment of the present disclosure, the restraint system may be used in areas of high wind.

In one embodiment, the longitudinal restraint system comprises a self-contained chassis, wherein the components of the longitudinal restraint system are housed. The chassis may be built around, or be part of a skid guide devised to skid along a skidding beam or capping rail. A person skilled in the art would recognize the benefit of a chassis as allowing the entire longitudinal restraint system to be disconnected from, and reconnected to, a movable structure. Therefore, longitudinal restraints engineered for higher or lower loads may be swapped out as required.

The longitudinal restraint system, according to one embodiment of the present disclosure, comprises jack screws. Jack screws may be hydraulic, but are preferably mechanical. Jack screws are coupled to the movable structure such that a portion of the jack screw may be extended to engage the chock, thereby seating the chock into the rack, and locking the chock in the longitudinal direction. Jack screws may be provided on any side of the chock, as required to prevent motion in the longitudinal direction, and may be torque limited to prevent damage to the screw mechanism or the chock. In one embodiment, the jack screw may also assist in moving the movable structure in the longitudinal direction.

According to one embodiment of the present disclosure, there is provided at least one vertical jack screw. A vertical jack screw may be hydraulic, but is preferably mechanical. The vertical jack screw may be extended to engage the chock in the vertical direction to assist the actuating cylinder in maintaining engagement between the rack and the chock. The vertical jack screw also provides additional means of preventing disengagement of the chock and the rack during external events like wind loading, wave activity, or seismic activity. In one embodiment, the vertical jack may also assist in moving the movable structure in the vertical direction.

There is provided, in one embodiment, remote actuation of the elements of the present disclosure. For example, at least one of the group consisting of the actuating device and the jack screw and the vertical jack screw is remotely actuated.

In one embodiment, the rack comprises a high friction surface, and the chock comprises a high friction surface, wherein the chock high friction surface is configured to engage the rack high friction surface. Optimally, the high friction surfaces comprise teeth.

According to the present disclosure, the movable structure may be skid along the skidding beam or capping rail via the skid guides. The entire movable structure may be coupled to only one longitudinal restraint system, or many longitudinal restraint systems may be employed. When the movable structure is in place, the actuating cylinder maneuvers the chock to engage the corresponding rack. In one embodiment, the actuating cylinder may pivot about a pivot point to align the chock with the rack. Multiple actuating cylinders may be provided. Jack screws may assist in placement of the chock and engagement of the chock to the rack. Upon engagement, horizontal jack screws may extend from either side of the chock to lock the chock in place longitudinally. Vertical jack screws may extend in the vertical direction to lock the chock to the rack in the vertical direction. The jack screws may be pitched or yawed around a pivot point as well in order to assist in locking the chock. The movable structure is thus restrained.

When it comes time to move the movable structure, the jack screws may be reversed to disengage the screws from the chock. The actuating cylinder may then disengage the chock from the rack, allowing the movable structure to be skid along the skidding beam in the longitudinal direction.

In one embodiment, a method for longitudinally restraining a movable structure comprises attaching a rack to a first structure, attaching a chock to a second structure, wherein the face of the chock is configured to engage the face of the rack. The chock is then positioned along the face of the rack such that the teeth of the rack align with the teeth of the chock, and the chock and rack are engaged. A locking mechanism attached to the second structure can be used to restrict the chock from moving along the longitudinal axis of the rack. Preferably, the locking mechanism is a jack screw. However, one skilled in the art would understand other types of locking mechanisms could be used. Optimally, such locking mechanisms would not depend on electrical power or hydraulic pressure to remain engaged.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1(a) is a side view of an embodiment of the locking system of the present disclosure;

FIG. 1(b) is an exploded view of an embodiment of the rack portion of the locking system of the present disclosure;

FIG. 2 is a top view of an embodiment of the locking system of the present disclosure;

FIG. 3 is an end view of an embodiment of the locking system of the present disclosure; and

FIG. 4 is a side view of an embodiment of the locking system of the present disclosure.

It should be understood that the drawings are not necessarily to scale and that the disclosed embodiments are sometimes illustrated diagrammatically and in partial views. In certain instances, details which are not necessary for an understanding of the disclosed methods and apparatuses or which render other details difficult to perceive may have been omitted. It should be understood, of course, that this disclosure is not limited to the particular embodiments illustrated herein.

### DETAILED DESCRIPTION OF THE INVENTION

The locking system of the present disclosure allows a movable structure to be temporarily restrained to a desired position on a fixed structure. In one embodiment, the fixed structure is a deck of a vessel, such as an offshore platform, the floor of any built structure, or any flat surface that is in a fixed position, and the desired position is a horizontal position along the deck, floor, or flat surface. Alternatively, the fixed structure is a wall, and the desired position a vertical position on that wall some distance above the floor or ground. In the preferred embodiment, the locking system of the present disclosure provides locking in the longitudinal direction of movement of a movable structure in the forward and aft or port and starboard direction on board the vessel.

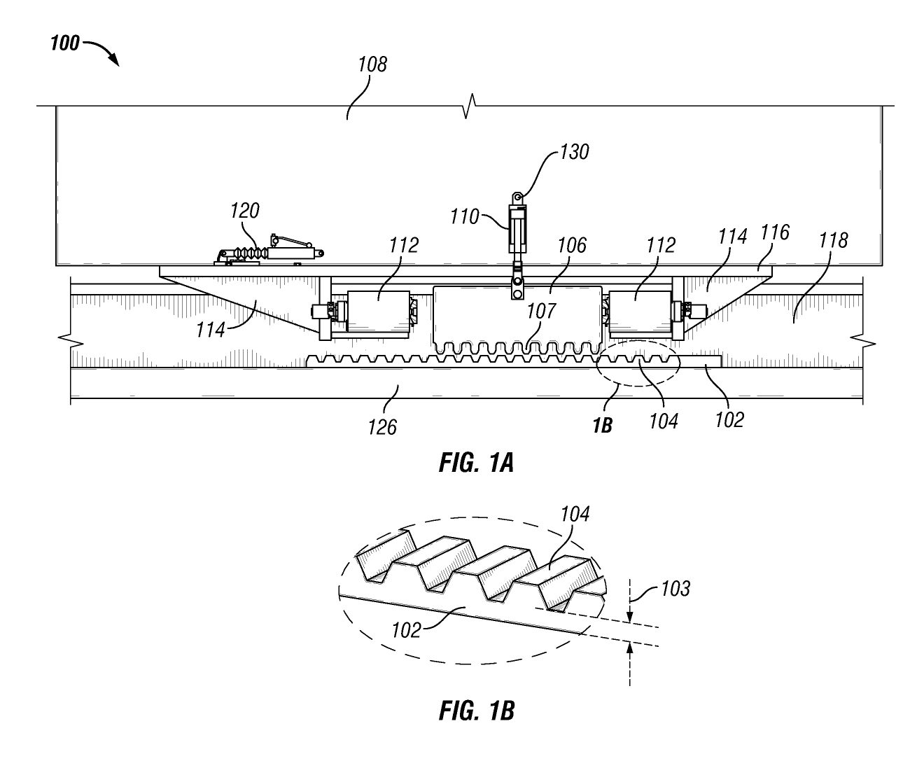

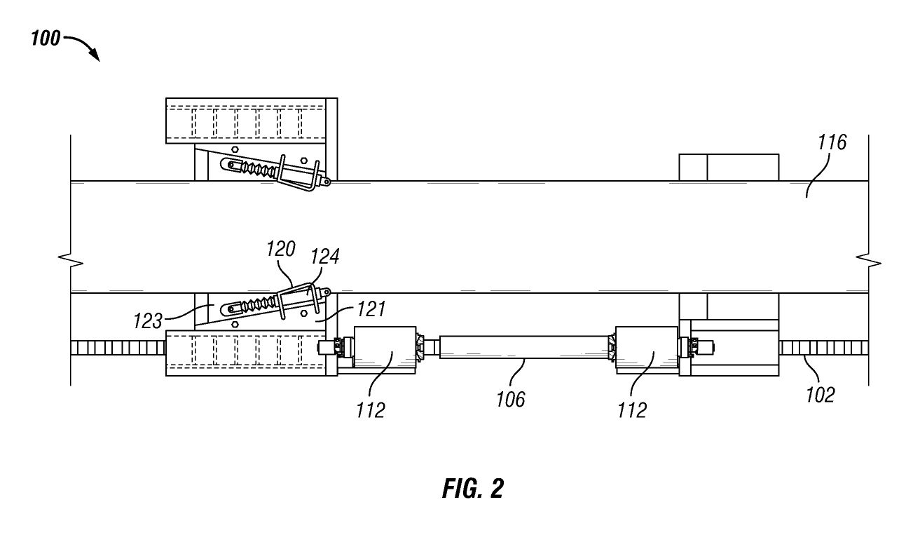

Referring to FIGS. 1(a), 1(b) and 2, rack 102 is shown attached to a fixed structure 126 along its length. The attachment can be done through welding, bolting, or other means known to those skilled in the art. Referring to FIG. 1(b), rack 102 includes a body 103 that defines a longitudinal axis extending there through. Body 103 is shown with a series of teeth 104 that extend away from the fixed structure 126. In the preferred embodiment where rack 102 is secured on the floor or deck of a vessel, teeth 104 face upward opposite the fixed structure. In an alternative embodiment, rack 102 may be secured on any available surface. For example, rack 102 may be positioned on a vertical wall or the bottom of a horizontal surface, such as a ceiling or the underside of a skidding beam. A person skilled in the art would understand how to rotate elements of restraint system 100 about the longitudinal axis to maintain the integrity of the invention. Multiple racks may be present in a given longitudinal direction, for example, along a skidding beam.

The locking system shown in FIG. 1(a) further comprises chock segment 106. Chock segment 106 is coupled to movable structure 108. In the embodiment of FIG. 1(a), movable structure 108 is movable relative to fixed structure 126. In one embodiment, chock segment 106 is coupled to movable structure 108 through at least actuating cylinder 110. When movable structure 108 is positioned at a certain location and it is desired that movable structure 108 be temporarily fixed or locked at that location, certain embodiments of the locking system of the present disclosure can be used to allow temporary immobilization of movable structure 108. While there are many applications for the embodiments of the locking system of the present disclosure, they are particularly useful for securing items on vessels due to the constantly moving nature of a floor or deck of that vessel or due to external forces such as wind loading or seismic activity.

Chock segment 106 includes teeth 107 shaped to engage teeth 104 of rack 102. When chock segment 106 is closed against rack 102, teeth 107 engage teeth 104 to lock chock segment 106 in position with respect to fixed structure 126. In the alternative, chock segment 106 may rest to the side of or underneath rack 102, such as where rack 102 is secured to a vertical surface or a horizontal surface above.

In the preferred embodiment, actuating cylinder 110 moves chock segment 106 into engagement with rack 104. Actuating cylinder 110 may be pivotally attached to movable structure 108 and chock 106. In embodiments in which movable structure 108 moves relative to chock 106, actuating cylinder 110 pivots at pivot points 130. Actuating cylinder 110 is configured to maintain pressure sufficient to ensure chock 106 remains engaged to rack 102 as actuating cylinder 110 pivots. Although one actuating cylinder 110 is shown, it is understood that multiple actuating cylinders could be used. Further, actuating cylinder 110 is shown in perpendicular alignment with rack 102. However, one skilled in the art understands the angle between the actuating cylinder 110 and rack 102 changes when movable structure is moved. In the case of multiple actuating cylinders, the angles of the actuating cylinders may be offset such that one cylinder is always in a perpendicular alignment with rack 102.

Chock segment 106 is disposed between a locking mechanism. The locking mechanism is configured to engage chock 106 in the longitudinal direction so that forces imparted on movable structure 108 by external events are transferred through chock 106 into rack 102. The locking mechanism may be hydraulic, but is preferably mechanical. It may be engaged electronically or manually.

In the exemplary embodiment shown in FIG. 1(a), the locking mechanism comprises two jack screws 112, configured to move or actuate in the direction parallel to the longitudinal direction of rack 102, which is generally perpendicular to the direction of movement of actuating cylinder 110. Actuating cylinder 110 and jack screws 112 are preferably actuated electrically or hydraulically. Jack screws 112 are preferably coupled to reaction plates 114, but can be affixed to any rigid component coupled to structure 108. After chock 106 is in position and is interlocked with the teeth of rack 102, drive or jack screws 112 can be actuated to extend a body of jack screws 112 until drive or jack screws 112 engage chock segment 106. Once jack screws 112 engage with chock segment 106, loads acting in the longitudinal direction along the body of rack 102 can be transferred between reaction plates 114. In this manner, jack screws 112 can be used to secure or move movable structure 108. When securing movable structure, jack screws on both sides of chock 106 are extended to engage chock 106. When moving movable structure 108, jack screws on one side of chock 106 are extended to push movable structure 108.

In the preferred embodiment, the pitch angles of rack 102 and chock segment 106 are such that forces in the longitudinal direction of motion (along the body of rack 102) are insufficient to overcome friction. Therefore, when load is applied in the longitudinal direction, friction via the vertical force along the engagement between rack 102 and chock 106 prevents longitudinal slide of the components in the restraint system. In this way, chock segment 106, along with movable structure 108 coupled to it, is locked in the longitudinal direction in a desired location through its engagement with stationary rack 102, which is attached to the fixed structure 126, even when load is applied in the longitudinal direction. Jack screws 112 become lock screws when load is applied.

For the teeth design shown in FIGS. 1(a), 1(b), and 4, rack teeth 104 match chock teeth 107. One skilled in the art would understand that various rack and chock designs are available. For example, the top land of either set of teeth may be flat or involute, as can be the bottom land. Teeth on either the rack or chock (or both) may have an edge round. The chordal thickness of the teeth need not match between the rack and the chock. The pitch angles of the teeth may be of varying degrees, depending on the preferred ease of engagement. In one embodiment, a saw tooth design is contemplated. In another embodiment, rack 102 and chock 106 do not have teeth, but rely on high friction surfaces as well known by those skilled in the art.

In the embodiment shown in FIG. 2, actuating cylinder 110 is configured to react to any additional load perpendicular to the longitudinal that may occur, for instance, from vertical vessel motion. In other words, actuating cylinder 110 can be configured to maintain engagement between chock 106 and rack 102 irrespective of the vertical load. In the present disclosure, the term “vertical” can mean the direction vertical to the horizontal floor or ground as well as a direction normal to the face of rack 102. It is understood that actuating cylinder 110 and jack screws 112 are configured to provide the appropriate force to support chock 106 and movable structure 108 in the lock position.

In one embodiment, jack screws 112 are also coupled to movable structure 108 to spread the load transfer between chock segment 106 and movable structure 108 to provide a more secure lock when chock 106 engages rack 102. Jack screws 112 can be welded or bolted to movable structure 108 or coupled through other appropriate means known to those skilled in the art. For example, jack screws 112 may be mounted on reaction plates 114.

In the embodiment shown in FIG. 4, additional jack screws are provided in the vertical direction. These vertical jack screws 111 can be coupled to movable structure 108 directly (not shown) or via a longitudinal restraint chassis 117. Chassis 117 may comprise skid guide 116 and reaction plates 114. It is understood that chassis 117 allows longitudinal restraint 100 to be disconnected from, and reconnected to, movable structure 108 without having to remove each component of longitudinal restraint 100. After chock segment 106 is in position and is interlocked with the teeth of rack 102, vertical jack screws 111 are actuated to extend a body of vertical jack screws 111 until vertical jack screws 111 engage chock segment 106. The vertical jack screws 111 assist actuating cylinders 110 in reacting to any additional load perpendicular to the longitudinal that may occur, for instance, from vertical vessel motion. Vertical jack screws 111 can be configured to mechanically assist in retaining chock 106 engaged and locked to rack 102 in the event that vertical load is applied in addition to or in place of the longitudinal load. Additionally, vertical jack screws 111 can be used to lift movable structure 108 or restraining system 100 relative to fixed structure 126.

In one embodiment, jack screws 112 impart enough force on chock 106 in the longitudinal direction to effectively slide movable structure 108 along skidding beam 118. This allows for the restraint system to facilitate minor tweaks in the position of movable structure 108 without engaging the main jack skidding system.

In another embodiment, certain elements of the locking system of the present disclosure are operated remotely and/or automatically. In the preferred embodiment, the movement and actuation of actuating cylinder 110, jack screws 112, and vertical jack screws 111 are remotely controlled so that the locking system of the present disclosure can be locked or unlocked remotely. The locking system of the present disclosure is particularly applicable to hold the footing of a large structure, such as a mobile drilling rig used in the oil and gas industry, on a vessel whether on land or sea. In other aspects, the embodiments of the present disclosure can be used to secure smaller items in environments that are subject to changing load applications.

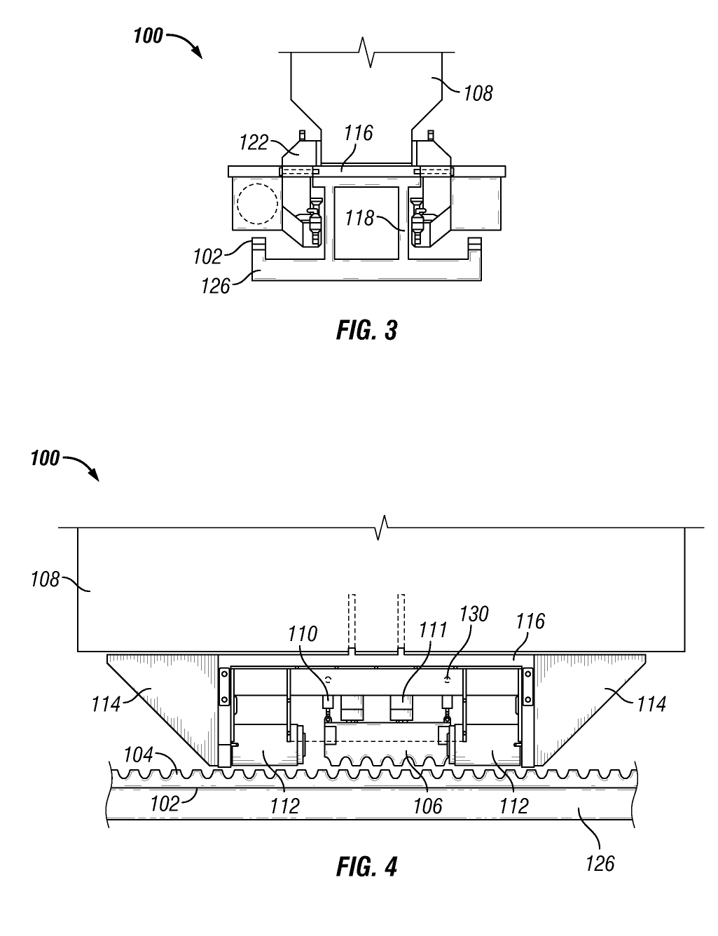

In one exemplary embodiment, referring to FIG. 3, movable structure 108 is a footing of a structure coupled to skid guide 116 and vertical skid guides 122. Skid guides 116 and vertical skid guides 122 slide along skidding beam 118. The upper half of vertical skid guides 122 also serve as vertical restraints for attachment of restraint system 100 to movable structure 108. Where movable structure 108 is to be secured to a deck 126 of vessel (not shown), movable structure 108 coupled to restraint system 100 is skidded to the desired position along skidding beam or capping rail 118 guided by skid guide 116 and vertical skid guides 122. Rack 102 is attached to the vessel at the desired location. When the desired position is achieved, chock 106 is engaged to rack 102 thus immobilizing structure 108 in the longitudinal direction.

In one embodiment, there are provided lateral restraints 120 comprising a fixed wedge 121, a travelling wedge 123, and a lateral restraint actuating cylinder 124. Referring to FIG. 2, fixed wedge 121 is firmly coupled to movable structure 108, preferably mounted on to the skid guides 116 or vertical skid guides 122 or chassis 117 of the longitudinal restraint. Travelling wedge 123 is coupled to lateral restraint actuating cylinder 124, and exists in the space between fixed wedge 121 and the lateral edge of skidding beam 118. As lateral restraint actuating cylinder 124 retracts, travelling wedge 123 is sandwiched in between fixed wedge 121 and the lateral edge of skidding beam 118, thereby making contact with said edge. Movable structure 108 is thus restrained in the lateral direction, perpendicular to the longitudinal axis of the skidding beam. When the movable structure 108 is to be relocated, lateral restraint actuating cylinder 124 extends, moving travelling wedge 123 away from the lateral edge of skidding beam 118. One skilled in the art would recognize that additional lateral restraints 120 may be added as required to constrain movable structure 108 in the lateral direction.

Coupled to movable structure 108 are actuating cylinder 110 and jack screws 112. In the unlock configuration, actuating cylinder 110 holds chock segment 106 above rack 102. Cylinder 110 can be remotely actuated to lower chock segment 106 until it engages rack 102. In the preferred embodiment, chock 106 is configured to be placed next to one jack screw 112. If chock segment 106 is lowered so that its teeth 107 properly align with teeth 104 of rack 102, the system can sense this when jack screw 112 next to chock segment 106 is actuated but cannot be moved beyond the specified maximum force. Jack screw 112 is torque limited. If chock segment 106 is lowered and its teeth are not properly aligned, when jack screw 112 closest to chock 106 is actuated, its specified force is sufficient to push chock 106 into proper alignment. After it is determined that chock 106 is properly aligned with rack 102, the other jack screw 112 can be actuated, preferably remotely, until it engages chock 106. In one embodiment, vertical reaction screws 111 are then engaged to mechanically resist vertical loads on chock 106. Vertical reaction screws 111 may also be torque limited. The locking system of the present disclosure is now in the lock configuration where movable structure 108 is secured to the vessel.

To unlock, each jack screw 112 can be actuated to withdraw from chock 106 sequentially or simultaneously. Vertical jack screws 111 are actuated to withdraw from chock 106 in the vertical direction. Cylinder 110 then can lift chock 106 to disengage it from rack 102. If movable structure 108 has four footings, there would be four corresponding movable structure 108 attachment points, four chock segments 106, and four racks 102 placed at the appropriate locations on the vessel for locking movable structure 108 to the vessel as described. In one embodiment, cylinder 110, jack screws 112, and vertical jack screws 111 can be programmed to operate remotely and automatically without manual control or user input during the locking and unlocking process.

As described, certain embodiments of the present disclosure allow for temporary locking of an object, large or small, in a location that can withstand loads in the horizontal (side to side) and vertical (up and down) directions. The embodiments of the locking system of the present disclosure are particularly applicable for securing structures of all sizes on a vessel, which often experiences loads in all directions (e.g., waves, wind, seismic, etc.). Further, certain embodiments of the present disclosure allow for the convenience of remote operation to lock or unlock the system.

Although the embodiments of the locking system of the present disclosure and their advantages have been described in detail, it should be understood that various changes, substitutions and alterations can be made herein without departing from the spirit and scope of the disclosure as defined by the future claims. Moreover, the scope of the present application is not intended to be limited to the particular embodiments of the process, machine, manufacture, composition of matter, means, methods and steps described in the specification. As one of ordinary skill in the art will readily appreciate from the present disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A longitudinal restraint system comprising:
a rack attached to a first structure;
a chock coupled to a second structure;
an actuating device configured to move the chock in relation to the rack; and
a locking mechanism coupled to the second structure, wherein a body of the locking mechanism is configured to engage a portion of the chock.

2. The longitudinal restraint system of claim 1 wherein the locking mechanism comprises at least one jack screw.

3. The longitudinal restraint system of claim 1
wherein the rack comprises a high friction surface; and
the chock comprises a high friction surface; wherein the chock high friction surface is configured to engage the rack high friction surface.

4. The longitudinal restraint system of claim 3 wherein the high friction surfaces are teeth.

5. The longitudinal restraint system of claim 1 wherein the actuating device is a hydraulic cylinder.

6. The longitudinal restraint system of claim 1 wherein the actuating device pivots about a pivot point.

7. The longitudinal restraint system of claim 1 further comprising a vertical jack screw.

8. The longitudinal restraint system of claim 1 wherein at least one of the group consisting of the actuating device and the locking mechanism is remotely actuated.

9. The longitudinal restraint system of claim 7 wherein at least one of the group consisting of the actuating device, the locking mechanism, and the vertical jack screw comprises a torque limiter.

10. The longitudinal restraint system of claim 1 wherein at least one jack screw is configured to move the second structure in relation to the first structure.

11. The longitudinal restraint system of claim 1 wherein the second structure is configured to slide on a skidding beam.

12. The longitudinal restraint system of claim 1 wherein the rack is attached to the first structure on a skidding beam.

13. The longitudinal restraint system of claim 1 further comprising a lateral restraint.

14. The longitudinal restraint system of claim 13 wherein the lateral restraint comprises:
a fixed wedge;
a travelling wedge; and
a lateral restraint actuating cylinder.

15. A longitudinal restraint system comprising:
a rack attached to a first structure;
a chassis attached to a second structure;
a chock coupled to the chassis;
an actuating device configured to move the chock in relation to the rack; and
a jack screw coupled to the chassis, wherein a body of the jack screw is configured to engage a portion of the chock.

16. The longitudinal restraint system of claim 15 wherein the chassis further comprises a skidding guide and reaction plates.

17. The longitudinal restraint system of claim 15 further comprising a vertical skid guide attached to the chassis.

18. The longitudinal restraint system of claim 15 further comprising at least one vertical jack screw coupled to the chassis.

19. The longitudinal restraint system of claim 15 wherein at least one jack screw is configured to move the second structure in relation to the first structure.

20. The longitudinal restraint system of claim 15
wherein the rack comprises a high friction surface; and
the chock comprises a high friction surface; wherein the chock high friction surface is configured to engage the rack high friction surface.

21. The longitudinal restraint system of claim 20 wherein the high friction surfaces are teeth.

22. The longitudinal restraint system of claim 18 wherein at least one of the group consisting of the actuating device, the jack screw, and the vertical jack screw comprises a torque limiter.

23. The longitudinal restraint system of claim 15 wherein the actuating device is a hydraulic cylinder.

24. The longitudinal restraint system of claim 15 further comprising a lateral restraint.

25. The longitudinal restraint system of claim 15 wherein the rack is attached to the first structure on a skidding beam.

26. A method for longitudinally restraining a movable structure comprising:
attaching a rack to a first structure;
attaching a chock to a second structure, wherein the face of the chock is configured to engage the face of the rack;
positioning the chock along the face of the rack, wherein the teeth of the rack align with the teeth of the chock;
attaching a locking mechanism to the second structure;
restricting the chock, by way of the locking mechanism, from moving along the longitudinal axis of the rack.

27. The method of claim 26 wherein the locking mechanism comprises at least one jack screw.

28. The method of claim 26 wherein the chock is positioned by an actuating cylinder attached to the second structure.

29. The method of claim 26 wherein at least one of the steps of positioning the chock and engaging the chock is completed remotely.

30. The method of claim 26 further comprising:
attaching at least one vertical jack screw to the second structure;
extending the vertical jack screw to engage a portion of the chock in the vertical direction.
